(19) United States
(12) Patent Application Publication
(10) Pub. No.: US 2004/0078699 A1
(43) Pub. Date: Apr. 22, 2004

(54) System for preventing translation lookaside buffer conflicts when generating and merging computer architecture test cases

(76) Inventors: Ryan C. Thompson, Fort Collins, CO (US); John W. May, LaPorte, CO (US)

Correspondence Address: HEWLETT-PACKARD COMPANY, Intellectual Property Administration, P.O. Box 272400, Fort Collins, CO, 80527-2400, US

(21) Appl. No.: 10/251,099

(22) Filed: Sep. 18, 2002

(51) Int. Cl. G06F 11/00

(52) U.S. Cl. 714/42

(57) ABSTRACT

A system for preventing translation cache/translation register initialization conflicts in dual-threaded computer processor architecture test cases. When each test case is generated, the test case generator is given a number T representing the total number translation cache entries and translation register entries which it can use. A first test case thread and a second test case thread are generated to produce a number of translation register entries and the number of translation cache entries equal to a value of no greater than T/4. Each of the translation register entries for the first test case thread and for the second test case thread is then moved to mutually exclusive slots in a range from 0 through (T/2−1). Finally, the translation cache entries for the first test case thread are moved to mutually exclusive slots (T−1) through T/2.

### TECHNICAL FIELD

The present invention relates generally to computer systems, and more particularly, to a system for preventing translation lookaside buffer conflicts when generating and merging test cases used in the development and testing of computer processor architectures.

### BACKGROUND

Modern computer systems typically use a structure called a translation lookaside buffer to map virtual program addresses to physical addresses in main memory. A particular implementation of a translation lookaside buffer comprises two types of entries, translation register and translation cache. When generating computer processor architecture test cases for a multi-threaded processor architecture, it is desirable to generate test cases with separate executable code streams, i.e., one code stream for each thread. Previously existing methods for generating multi-threaded test cases typically separately generate single-threaded test cases and merge them into one test case. When these methods are employed, each of the test cases which are merged must not initialize a translation cache entry or translation register entry that another case has also initialized, otherwise the desired behavior of the individual test cases will not occur.

Previously, test cases were generated and then checked to see if any translation cache or translation register initializations overlapped. If an overlap was detected, a separate script could be written to attempt to rearrange the entries, but if more entries were initialized than were available in the architecture, the script would fail.

Since the memory allocation performed by presently existing tools does not insure that there is not a conflict between initial translation cache entries and translation register entries, a need thus exists for a method to assure that translation lookaside buffer initialization conflicts between the test cases does not occur when the cases are generated.

### SUMMARY

The present system overcomes the aforementioned problems of the prior art and achieves an advance in the field by providing a system for preventing translation cache/translation register initialization conflicts in dual-threaded computer processor architecture test cases. When each test case is generated, the test case generator is given a number T representing the total number translation cache entries and translation register entries which it can use. A first test case thread and a second test case thread are generated to produce a number of translation register entries and the number of translation cache entries equal to a value of no greater than T/4. Each of the translation register entries for the first test case thread and for the second test case thread is then moved to mutually exclusive slots in a range from 0 through (T/2−1). Finally, the translation cache entries for the first test case thread are moved to mutually exclusive slots (T−1) through T/2.

### BRIEF DESCRIPTION OF THE DRAWINGS

FIG. 1 is a diagram illustrating one embodiment of memory in a target computer system for which the present system generates Translation Lookaside Buffer entries;

FIG. 2 is a diagram illustrating an example showing memory allocation for a multi-threaded test case; and

FIG. 3 is a flowchart showing exemplary steps performed in one embodiment of the present system.

### DETAILED DESCRIPTION

Modern computer systems use virtual memory to allow multiple programs to run simultaneously on a single machine, without encountering memory conflicts, and to allow programs to use more memory space than is physically available in a computer system. In these systems each program, therefore, uses ‘virtual’ memory addresses. Each time a virtual address is used, the computer system translates it to an address in the physical memory available in the computer. The mappings of all the virtual to physical addresses are kept in a table (in memory, on hard disk, or on both, depending on the size of the table) which is accessed when a translation is needed. This access is relatively slow, so a smaller buffer of recently used translations is kept in a structure that can be accessed very quickly. This structure is called a Translation Lookaside Buffer.

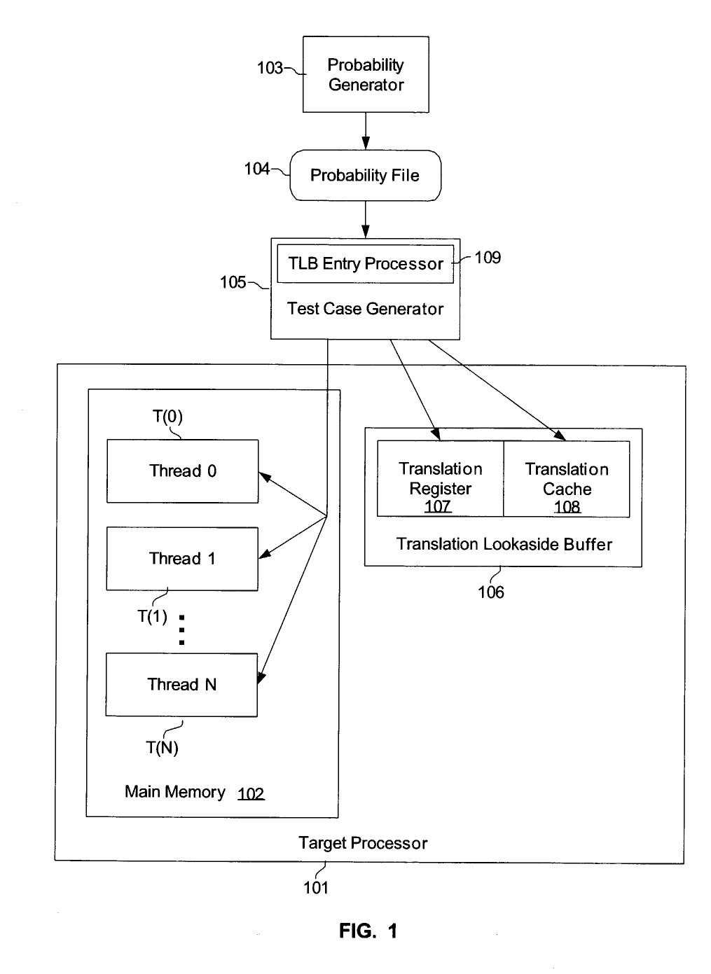

FIG. 1 is a diagram illustrating exemplary components in a computer system environment in which the present system functions. As shown in FIG. 1, target processor 101, whose architecture is to be tested, includes main memory 102, which the present system will set up to contain code for at least two test cases, indicated by Thread 0 and Thread 1 (threads T0 and T1, respectively). Target processor also includes a Translation Lookaside Buffer (TLB) 106. TLB 106 comprises two types of entries, Translation Register (TR) entries 107 and Translation Cache (TC) entries 108.

Initially, a probability generator 103 generates a probability file 104 containing a structure indicating the memory range for each case and a probability value for determining the actual number of initial Translation Register and Translation Cache entries for each case in a given test run. The probability file 104 is then input to a test case generator 105, which generates the threads for each test case and re-configures the entries in the Translation Lookaside Buffer in accordance with the method described below.

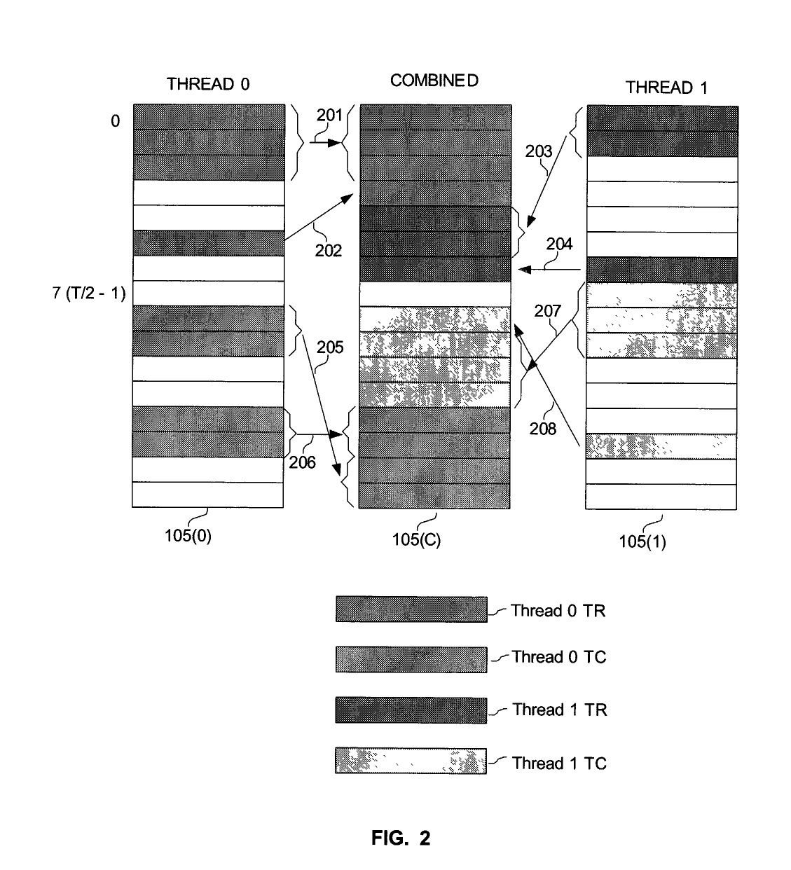

FIG. 2 is a diagram illustrating an exemplary Translation Lookaside Buffer (TLB) 106 having 16 slots, which, for the sake of clarity, has been reduced in size from that of a typical TLB, which may comprise 128 slots. As indicated above, the Translation Lookaside Buffer comprises two types of entries, Translation Register 107 and Translation Cache 108. A difference between the two types of entries is that the Translation Register entries can only be explicitly removed. The Translation Cache entries can be removed automatically, by an entity external to the present system, if space for a new entry is needed. Of the total entries available in Translation Lookaside Buffer 106, half of these entries can be either a Translation Register entry 107 or a Translation Cache entry 108. The other half of the entries can only be Translation Cache entries 108. The order in which entries are arranged in the Translation Lookaside Buffer is not important, as long as the above rule is adhered to, i.e., as long as slots 0−(T/2−1) contain either Translation Register or Translation Cache entries, and slots (T/2)−(T−1) contain only Translation Cache entries. When a single thread test case is generated, the test case generator uses all or a subset of a total of R TR entries and C TC entries, according to the above restrictions, assuming that there are T TLB slots available. Note that T will be an even number in any typical implementation. The range of values for R and C in the table below represent the number of respective entries in the Translation Lookaside Buffer for a single thread test case.

TLB Entries for Single Thread

0≦R≦T/2

0≦C≦(T−R)

where

T =total number of TLB slots available;

R =number of TR entries, and

C =number of TC entries

For a multithread processor 101, the goal is to combine N single-threaded test cases to create a single multi-threaded test case. In the present example, two test cases are to be combined. In order to do this, each of the two test cases is generated with the following input for determining restrictions on the number of entries per thread:

Entries per Thread for Two Test Cases

0≦R≦T/4

0≦C≦T/4

where

T =total number of TLB slots available;

R =number of TR entries to initialize for a given thread, and

C =number of TC entries to initialize for a given thread

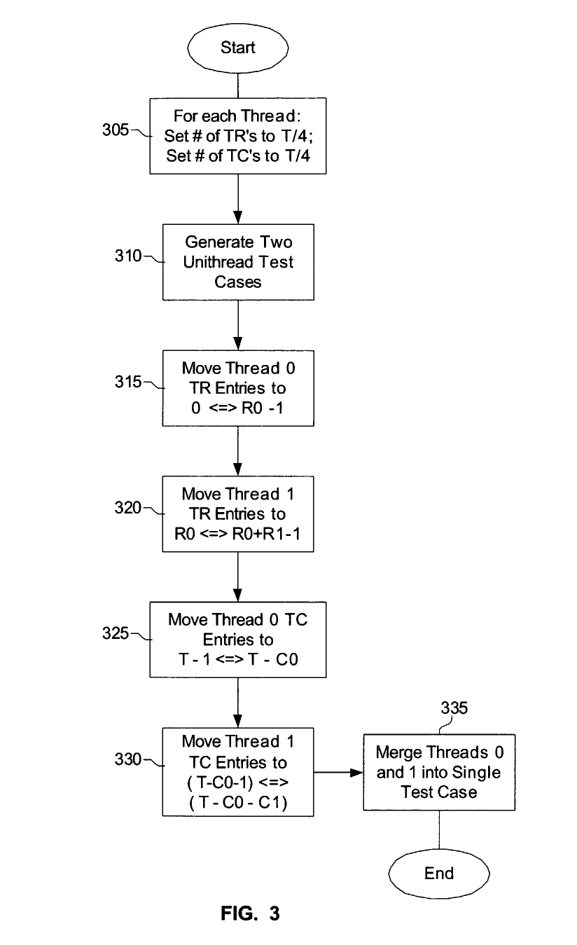

FIG. 3 is a flowchart showing exemplary steps performed in one embodiment of the present system. As shown in FIG. 3, at step 305, for each thread, the number of Translation Register entries 107, and the number of Translation Cache entries 108 are set to a value of T/4, where T equals the total number of slots available in Translation Lookaside Buffer 106.

At step 310, test case generator 105 generates two singlethread test cases, shown in FIG. 1 as Thread 0 and Thread 1 (threads TO and T1, respectively), using the T/4 maximum values for each of the Translation Register entries and the Translation Cache entries. A table showing the abbreviated terminology used for reference to entries in the Translation Lookaside Buffer is set forth below:

R0: number of Translation Register entries in Thread 0 case

R1: number of Translation Register entries in Thread 1 case

C0: number of Translation Cache entries in Thread 0 case

C1: number of Translation Cache entries in Thread 1 case

The test case generator 105 generates Translation Register and Translation Cache entries in the Translation Lookaside Buffer 106, the number of which is determined by data in the probability file 104 representing a percentage of the maximum number of entries (T/4) for both Translation Register and Translation Cache. The resulting number of entries in the Translation Lookaside Buffer for each entry R0, R1, C0, and C1 is between 0 and T/4.

The entries in Translation Lookaside Buffer (TLB) 106 are assigned by the generator into slots numbered from 0 to T−1. The Translation Register entries 107 for both threads are initially placed into slots numbered from 0 to (T/2−1). The Translation Cache entries 108 may, initially, be placed into any of the TLB slots by the test case generator. Note that while the test case generator is given instructions indicating the number of entries to generate using a probability scheme, it is not practicable to tell the generator in which slots to place those entries. Therefore, the entries are repositioned (moved within the TLB), explained below, after the two cases are generated, so that the test cases can be successfully combined.

At steps 315 through 330, each of the original entries in Translation Lookaside Buffer 106 are moved as necessary by a TLB entry processor 109 (a program that moves the entries and merges the test cases) within the TLB, in accordance with the procedure described below. At step 335, Threads 0 and 1 are merged (by TLB entry processor 109) into a single test case, which is now free of Translation Cache and Translation Register initialization conflicts.

In an exemplary embodiment of the present system, the original Translation Register entries in the Translation Lookaside Buffer 106 are moved within the TLB, with the entries being selected in ascending order by original slot number. These Translation Register entries are moved to TLB slots 0 through (R0+R1−1), in ascending order by slot number for Thread 0, and then for Thread 1. The original Translation Cache entries in TLB 106 are then moved within the TLB, with the entries being selected in ascending order by original slot number. These Translation Cache entries are moved to TLB slots T through (T−C0−C1), in descending order by slot number for Thread 0, and then for Thread 1. However, it should be noted that the entries may, alternatively, be moved in any order to produces any resulting slot configuration consistent with the rule that no more than half of the entries are either a Translation Register entry 107 or a Translation Cache entry 108, and the other half of the entries can only be Translation Cache entries 108.

As shown in FIG. 2, and indicated in the corresponding example described below, there are 16 total slots in Translation Lookaside Buffer 106 (where the number associated with each entry is the slot number assigned by the test case generator). Operation of the present system is best understood by viewing FIGS. 2 and 3 in conjunction with one another, wherein the Translation Register and Translation Cache entries in the Translation Lookaside Buffer 106 have the following original slot assignments.

Thread 0 case TLB initial slot assignments:

| Translation Register | Translation Cache |
|---|---|
| TR0 | TC8 |
| TR1 | TC9 |
| TR2 | TC12 |
| TR5 | TC13 |

Thread 1 case TLB initial slot assignments:

| Translation Register | Translation Cache |
|---|---|
| TR0 | TC7 |
| TR1 | TC8 |
| TR6 | TC9 |
| | TC13 |

Note that there are a number of conflicting slot assignments created by the test case generator, e.g., threads 0 and 1 both have Translation Register entries assigned to TLB slots 0-1, and both threads have Translation Cache entries assigned to slots 8-9, etc.

More specifically, at step 315, each of the Thread 0 Translation Register entries 107 is moved by TLB entry processor 109 to one of the slots 0 through (R0−1) in Translation Lookaside Buffer 106 (where R0 is the number of Translation Register entries for the Thread 0 case). Accordingly, the Thread 0 Translation Register entries in slots 0 through 2 are first ‘moved’ to the corresponding first three slots (0-2) in the TLB, as shown by arrow 201 in FIG. 2. Since these particular entries were already in those specific slots, they thus remain in slots 0 to 2. The next (and final) Thread 0 Translation Register entry, in TLB slot 5, is moved to slot 3 (corresponding to slot R0−1), as shown by arrow 202. At step 320, the thread 1 Translation Register entries are then placed into slots [slots 4-6] of the Translation Lookaside Buffer, as shown by arrows 203 and 204.

Slots in the Translation Lookaside Buffer 106 are filled by Translation Cache entries 108 in a manner similar to that described above for Translation Register entries, but starting from the other end of the TLB, i.e., by filling the TLB slots starting at slot T−1, in descending slot number order. Accordingly, at step 325, each of the Thread 0 Translation Register entries is moved by TLB entry processor 109 to one of the slots (T−1) through (T−C0) [slots 12-15] in Translation Lookaside Buffer 106 (where C0 is the number of Translation Cache entries for the Thread 0 case), as shown by arrows 205 and 206. Finally, at step 330, Thread 1 Translation Cache entries are moved to Translation Lookaside Buffer slots (T−C0−1) through (T−C0−C1) [slots 8-11 ], as indicated by arrows 207 and 208, to produce the resulting configuration of Translation Register and Translation Cache entries 107/108 in translation Lookaside Buffer 106, shown below and in FIG. 2:

Final configuration of initial slot assignments:

| TLB slot | Thread | Type | Orig. Slot |
|---|---|---|---|
| 0 | 0 | TR | 0 |
| 1 | 0 | TR | 1 |
| 2 | 0 | TR | 2 |
| 3 | 1 | TR | 5 |
| 4 | 1 | TR | 0 |
| 5 | 1 | TR | 1 |
| 6 | 1 | TR | 6 |
| 7 | — | — | — |
| 8 | 1 | TC | 13 |
| 9 | 1 | TC | 7 |
| 10 | 1 | TC | 8 |
| 11 | 1 | TC | 9 |
| 12 | 0 | TC | 12 |
| 13 | 0 | TC | 13 |
| 14 | 0 | TC | 8 |
| 15 | 0 | TC | 9 |

While exemplary embodiments of the present invention have been shown in the drawings and described above, it will be apparent to one skilled in the art that various embodiments of the present invention are possible. For example, the configuration of system components shown in FIG. 1, as well as the specific set of steps shown in FIG. 3, and the examples used in FIG. 2 and elsewhere herein, should not be construed as limited to the specific embodiments described in this document. Modification may be made to these and other specific elements of the invention without departing from its spirit and scope as expressed in the following claims.

What is claimed is:

1. A method for preventing translation lookaside buffer initialization conflicts when generating a first test case thread and a second test case thread, wherein there are a total number of T slots for translation register entries and translation cache entries available in a translation lookaside buffer, the system comprising the steps of:
generating a first test case thread and a second test case thread, to produce a number of translation register entries and the number of translation cache entries equal to a value of no greater than T/4;
moving each of the translation register entries for the first test case thread and for the second test case thread to mutually exclusive said slots in a range from 0 through (T/2−1); and
moving the translation cache entries for the first test case thread to mutually exclusive said slots (T−1) through T/2.

2. The method of claim 1, wherein a probability generator generates a number of entries in the translation lookaside buffer corresponding to R0, R1, C0, and C1, wherein:
R0 equals the number of said translation register entries for the first test case thread;
R1 equals the number of said translation register entries for the second test case thread;
C0 equals the number of said translation cache entries for the first test case thread; and
C1 equals the number of said translation cache entries for the second test case thread;
and wherein:
the translation register entries for the first test case thread are moved to said slots 0 through (R0−1);
the translation register entries for the second test case thread are moved to said slots R0 through (R0+R1−1);
the translation cache entries for the first test case thread are moved to said slots (T−1) through (T−C0); and
the translation cache entries for the second test case thread are moved to said slots (T−C0−1) through (T−C0−C1).

3. The method of claim 2, including the additional step of merging the first thread and the second thread to create a multi-thread test case.

4. A system for preventing translation lookaside buffer initialization conflicts when generating test cases, wherein there are a total number of T slots for translation register entries and translation cache entries available in a translation lookaside buffer, and wherein the slots are numbered from 0 to (T−1), the system comprising the steps of:
generating a first test case thread and a second test case thread, each having a number of translation register entries and the number of translation cache entries set to a value of T/4;
moving the translation register entries for the first test case thread to said slots 0 through (T/4−1);
moving the translation register entries for the second test case thread to said slots T/4 through (T/2−1);
moving the translation cache entries for the first test case thread to said slots (T−1) through (T−T/4); and
moving the translation cache entries for the second test case thread to said slots (T−T/4−1) through (T−T/2).

5. The system of claim 4, wherein a number of entries in the translation lookaside buffer are generated, the entries corresponding to R0, R1, C0, and C1, wherein R0 equals the number of translation register entries for the first test case thread; R1 equals the number of translation register entries for the second test case thread; C0 equals the number of translation cache entries for the first test case thread; and C1 equals the number of translation cache entries for the second test case thread;
and wherein:
the translation register entries for the first test case thread are moved to said slots 0 through (R0−1);
the translation register entries for the second test case thread are moved to said slots R0 through (R0+R1−1);
the translation cache entries for the first test case thread are moved to said slots T−1) through (T−C0); and
the translation cache entries for the second test case thread are moved to said slots (T−C0−1) through (T−C0−C1).

6. The system of claim 5, wherein a probability generator is used to generate said entries corresponding to R0, R1, C0, and C1.

7. The system of claim 6, including the additional step of merging the first thread and the second thread to create a multi-thread test case.

8. A system for preventing translation lookaside buffer initialization conflicts when generating a first test case thread and a second test case thread, wherein there are a total number of T slots for translation register entries and translation cache entries available in a translation lookaside buffer, and wherein the slots are numbered from 0 to (T−1), the system comprising the steps of:
generating a first test case thread and a second test case thread with a number of translation register entries and the number of translation cache entries each set to a value of T/4;
generating a number of entries in the translation lookaside buffer corresponding to R0, R1, C0, and C1; wherein:
R0 equals the number of translation register entries for the first thread;
R1 equals the number of translation register entries for the second thread;
C0 equals the number of translation cache entries for the first thread; and
C1 equals the number of translation cache entries for the second thread;
moving the translation register entries for the first test case thread to slots 0 through (R0−1);
moving the translation register entries for the second test case thread to slots R0 through (R0+R1−1);
moving the translation cache entries for the first test case thread to slots (T−1) through (T−C0); and
moving the translation cache entries for the second test case thread to slots (T−C0−1) through (T−C0−C1).

9. The system of claim 8, including the additional step of merging the first thread and the second thread to create a multi-thread test case.

10. A system for preventing translation lookaside buffer initialization conflicts when generating test cases, the system comprising:
means for generating a first test case thread and a second test case thread with a number of translation register entries and the number of entries in said translation cache each set to a value of T/4; and
means for generating a number of entries in the translation lookaside buffer corresponding to R0, R1, C0, and C1; wherein:
R0 equals the number of translation register entries for the first thread;
R1 equals the number of translation register entries for the second thread;
C0 equals the number of translation cache entries for the first thread;
and
C1 equals the number of translation cache entries for the second thread; and
means for moving:
the translation register entries for the first test case thread to slots 0 through (R0−1);
the translation register entries for the second test case thread to slots R0 through (R0 +R1−1);
the translation cache entries for the first test case thread to slots (T−1) through (T−C0); and
the translation cache entries for the second test case thread to slots (T−C0−1) through (T−C0−C1).
